(19) United States
(12) Patent Application Publication
(10) Pub. No.: US 2020/0283225 A1
(43) Pub. Date: Sep. 10, 2020

(54) Apparatus, System and Method for Providing Enhanced Consumable Food Stuffs

(71) Applicant: Core Nutrition Systems, LLC, Glenmore, PA (US)

(72) Inventor: Steven Musacchio, Glenmore, PA (US)

(73) Assignee: Core Nutrition Systems, LLC, Glenmore, PA (US)

(21) Appl. No.: 16/813,377

(22) Filed: Mar. 9, 2020

Related U.S. Application Data
(60) Provisional application No. 62/815,582, filed on Mar. 8, 2019.

(51) Int. Cl. B65D 85/804; A23L 2/66; A23L 33/22; A23L 33/115; A23L 33/15

(52) U.S. Cl. CPC B65D 85/8043; A23L 2/66; A23V 2002/00; A23L 33/115; A23L 33/15; A23L 33/22

(57) ABSTRACT

A container mixes caffeine-based and non-caffeine-based consumables with various additional supplements for consumption. The container includes multiple chambers to hold pre-defined amounts of consumables. The container mixes the consumables in response to either a user instruction or as part of an automated process. Consumables include protein, fiber, creaming, healthy fats, electrolytes, or antioxidants.

### PRIORITY

N/A

### FIELD OF THE INVENTION

The present invention is directed to enhanced food stuffs, and, more specifically, to an apparatus, system and method for providing enhanced food stuffs.

### BACKGROUND

Many liquid beverages available for consumer purchase contain vitamins, nutrients, and/or energy, usually counted as calories. Some of these beverages are made to simply taste good, while others are meant to provide nutrition otherwise lacking in the diet of the user. However, the combination of various elements to provide a beverage useful for those with otherwise complete diets has been absent from the current marketplace.

There is a need therefore for a system, method and formula for providing a customer facing consumable suitable to provide additional elements to an established diet. To address this need, the present invention includes a system, method, and formula for providing fortified consumables in a convenient delivery system.

### BRIEF SUMMARY OF THE INVENTION

The present invention includes an apparatus, system and method of delivering consumables, such as caffeine-based or non-caffeine-based, in conjunction with various additional supplements in a container which may keep at least one first portion of the consumable partially segregated from at least one second portion of the consumable. Supplements may include flavoring, dietary, medicinal, or the like. The apparatus, system and method may include a multi-chamber bottle which may allow for the consumption of at least one of the portions of the consumable by a user.

More specifically, the present invention provides for a consumable which may have both nutritional value and a drug, such as caffeine. Thus, the present invention provides a fast, simple, inexpensive, and a most preferred fortified consumable in a container.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 illustrates an embodiment of the present invention;

FIG. 2A illustrates an embodiment of the present invention;

FIG. 2B illustrates an exemplary workflow diagram of at least one embodiment of the present invention;

FIG. 3 illustrates an embodiment of the present invention; and

FIG. 4 illustrates another exemplary embodiment of the present invention.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

The terminology used herein is for the purpose of describing particular exemplary embodiments only and is not intended to be limiting. For example, as used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “engaged to,” “connected to,” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer, or section without departing from the teachings of the exemplary embodiments.

The present invention may include a consumable which may include a general class of protein, fats, carbohydrates, for example. Proteins may come in many known forms and may include, for example, protein isolates and protein concentrates. Fats, which may be collected from either animal or plant sources, may include monounsaturated fats, polyunsaturated fats, saturated fats, or any combination thereof. Similarly, carbohydrate, which may also be derived from plant or animal sources, may include soluble fibers, complex carbohydrate bulking agents, sugars and combinations thereof.

In an embodiment of the present invention, base liquids may be used as at least a portion of the consumable and may include, for example, milk products. Such milk products may include those derived from both plant and/or animal sources and may include, for example, animal milk, coconut milk, almond milk, cashew milk, soy milk, and the like. Animal milk may include any animal derived milk and may, for example, include cow's milk. Any milk used may be included in various concentrations, have various fat content levels, be dried, be a liquid, and be included in combinations thereof. In an embodiment of the present invention, liquid milk may be treated to be self-stable and may, for example, be pasteurized.

In an embodiment of the present invention, natural flavors may be used such as, for example, vanilla, mocha, hazelnut, and the like. Similarly, any flavoring is contemplated, such as, for example, bacon, pancake, and/or popular unhealthy breakfasts.

In an embodiment of the present invention, natural emulsifying agents may be used, such as, Mono and diglycerides (Vegetable or animal source) and modified food starches.

In an embodiment of the present invention, PH buffering agents may be used, such as, sodium citrate and dipotassium phosphate.

In an embodiment of the present invention, zero or near-zero calorie sweeteners may be used, such as Stevia, Monk Fruit Extract, or Sugar Alcohols.

In an embodiment of the present invention, natural flow agents may be used, such as, for example, sodium aluminosilicate and other silica/silicate products.

In an embodiment of the present invention, added “health-benefit” ingredients, such as, for example, “Health” Oils, Coconut Oil, Flax Oil, Olive Oil, Almond and other nut oils, EPA/DHA Marine Oil, Sunflower Oil, and the like, may be used.

In an embodiment of the present invention, electrolytes may be added or may be a component of the consumable.

In an embodiment of the present invention, probiotics may be added or may be a component of the consumable.

In an embodiment of the present invention, whole food Antioxidant Blends may be added or may be a component of the consumable, such as, for example, Blueberry Extract, Acai Berry Extract, Grapeseed Extract, Coffee Bean Extract, Green Tea Leaf Extract, Broccoli Powder, and the like.

In an embodiment of the present invention, optional mineral additions may be added or may be a component of the consumable, such as, for example, iron, iodine, and the like.

In an embodiment of the present invention, natural energy boosting may be added or may be a component of the consumable, such as, for example, B Vitamin Complex and the like.

In an embodiment of the present invention, the consumable may be used as a meal replacement and may be used with, for example, 8 oz. of a beverage.

In an embodiment of the present invention, the consumable may be used as a special dietary use.

In yet another embodiment of the present invention, the consumable may include pharmaceutical or medicinal ingredients thereby providing a means for distributing medicine, such as Tylenol®, NSAIDs, or other medications, prescription or non-prescription.

In an embodiment of the present invention, the consumable may be shelf stable.

In an embodiment of the present invention, the consumable may be highly soluble in HOT or COLD beverage applications.

In an embodiment of the present invention, the consumable may be all natural.

In an embodiment of the present invention, the consumable may be a liquid and/or a powder and may be encapsulated.

In an embodiment of the present invention, the consumable may be housed in a bottle having a single or a plurality of chambers and may be in a packet form.

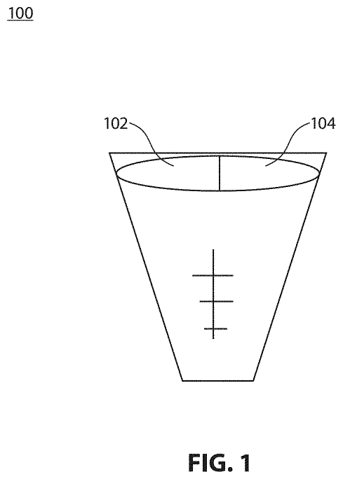

In an embodiment of the present invention, and as shown in FIG. 1, a two-chambered bottle 100 with two sealed openings (102, 104) to house 1) the creamer agents and 2) the vitamin and health fortifying agents (potentially solely the multivitamin ingredients) may be used. Similarly, the product may be partially dispensed from a larger bottle or tetrapak housing, for example.

The present invention may be made specifically for the nutritional demands of each user, making this a “Coffee Creamer Nutritional System for World Health”—This would cause slight changes in protein content, total calories, RDA amounts for vitamin fortification, the addition of caffeine for added energy, the addition of Vitamin K1/K2 for Bone Density for 50+ ages, etc. The present invention may be used, but is not limited to, with men, women, seniors, adolescents, athletes, military usage/soldiers in the field, diabetics, post-gastric bypass patients, energy boosting for students, prenatal care, for delivering medication to users, and for breakfast lovers. Formulations from 0-stated may also be tested and specific to certain manufactures cups (e.g., K-cups®). A total of 0-6 grams of total supplement powder typically allows for enough room with the aforementioned filling process. The mixture allows for the filling with enough liquid (e.g., coffee) to maximally fill the manufactured cups and still deliver the taste consumers expect.

In an embodiment of the present invention, the consumable may include caffeine boosting elements and may include electrolyte replacement additives.

In an embodiment of the present invention, the consumable may include unique flavors, such as, for example, savory flavors: Cocoa Chipotle, home-cooked bacon, or Belgian waffles.

In an embodiment of the present invention, seven main categories may be exploited:
1. Protein: Fava, Lentil, Pea Agglomerated-more for men, athletes, military
2. Fiber: Liquid Fiber from Cargill or Vitafiber/Orafti GR
3. Health-Boosting Oil: MCT Oil, EPA/DHA Oil, CLA Omega 3 Oil, Coconut Oil (here on in Creaming Agents), Flax Oil, (EVOO?)
4. Multivitamin: specified for target population: Men, Women, Adolescents
5. Antioxidant Whole Food Blend Boost/Electrolytes
6. Exotics-for target market: Could be-Energy(Caffeine/B-Complex), Bone Density(Calcium/D3), appetite suppressant for weight loss, appetite enhancing for elderly
7. Rx Meds/Over the Counter (Tylenol® could be added in a chamber)

| | | Amount | | Percentage of | Target |
|---|---|---|---|---|---|
| Marketable Categories | Ingredient Used | Used | | Total Formula | Market |
| Protein | Pisane ® C9 Pea Protein | 13 | grams | 35 | all |
| | | | | | populations |
| “Healthy” Fats | Coconut Cream (Trader | 26 | grams | 47 | |
| | Joe's ®) | | | | |
| Dietary Fiber | Orafti ® GR Chicory | 6 | grams | 14 | |
| Multivitamin | CVS ® Men's Multi. | 1 | tablet | | |
| Antioxidants | N/A | | | | |
| Probiotics | N/A | | | | |
| Electrolytes | N/A | | | | |
| Niche Ingredient for Target | N/A | | | | |
| Health Market | | | | | |
| “Exotic Ingredient” | | | | | |
| Natural Flavors | Flavor Dynamics ® | 2 | grams | 5 | |
| | Natural Vanilla | | | | |
| Natural Sweeteners | Purefruit ®: Stevia/ | 0.1 | grams | | |
| | Monkfruit ® | | | | |
| Emulisfiers | Vegetable Glycerine | 1.0 | grams | | |

| PH Regulators | N/A |
|---|---|
| Thickening Agents | N/A: Xanthan gum added |
| | to Coconut Cream |
| Formula | |
| Performance Ratings | |
| | Score: 1-5 (1 = Poor & |
| Category | 5 = Excellent) |
| Solubility | 4 |
| Taste | 3 |
| Color/Appearance | 4 |
| Viscosity/Mouth Fat Feel | 4 |
| on Tongue | |
| Smell Before Oral | 3 |
| Consumption | |
| Clean Label Confidence | 4 |
| Aftertaste | 3 |
| Hunger Saiety upon | 4 |
| completion | |
| Vegan Formulation (Y/N) | Y |

In an embodiment of the present invention, glycerine is used to help with emulsification and fat-feel. Purefruit® may be used and may be used in conjunction with Erythritol. Similarly, pea protein isolate may be used for a vegan blend, for example.

In an embodiment of the present invention, the consumable may contain one or more of the following: Protein, Fiber, Omega 3 fats and MCT Oil Fats. Sunflower Fat, electrolytes, whole food antioxidants, probiotics, increased energy through b-vitamin balance, and a daily multivitamin component.

In an embodiment of the present invention, the consumable may be combined with an eight ounce cup of coffee: a “Meal” according to the FDA's new rules and regulations (there is still a lot of grey area).

In an embodiment of the present invention, the consumable may contain 5 grams of protein per bottle (as much as a medium egg), 5 grams of prebiotic dietary fiber, only 5 net carbs per bottle, be made with all natural ingredients and flavorings, be vegan, gluten free, soy free, a daily multivitamin, natural hydrating aid from electrolytes, antioxidant boosts from Goji Berries and Green Tea Extract, heart healthy and satisfying fats from MCT Oil and Sunflower Oil, and may be 100 calories or less (can customize but should be capped at 100).

In an embodiment of the present invention, the consumable may have a solute to solvent ratio: 39.11:90.5=43.2% and a total weight: 129.61.

In an embodiment of the present invention, the consumable may have a solute to solvent ratio of: 43-45%.

The following are illustrative examples of embodiments of the present invention:

### French Vanilla Trial 1:

### TIC: 0.03

### Masking: 0.08

Sensory: 4 grams (0.5 grams)
Pea: 4.5 grams (4.1 grams of protein)
French Vanilla: 1.75 grams
Coffee Flavor: 0.5 grams
Vanilla Extract: 2 grams
Coconut Sugar: 4 grams (1 teaspoon)
Fiber: 5 grams
MCT Oil: 3 grams
Electrolyte Tablets: 1 serving
Goji Berry Powder: 05 grams
Green Tea Powder: 0.06 grams
Probiotic (1 billion colony): 0.07 grams
Multivitamin: 1 daily dosage (CVS Private Label Brand)
Coconut Milk: 40 grams
Very paint like
Great smell
Great consistency
With 8 oz cup of coffee: very vanilla-like and sweet . . . good! Less chalky

### Mocha Trial 1:

### TIC: 0.03

### Masking: 0.08

Sensory: 4 grams (0.5 grams)
Pea: 4.5 grams (4.1 grams of protein)
Mocha Flavoring: 3 grams
Cocoa Powder: 2 grams
Coffee Flavor: 0.5 grams
Coconut Sugar: 4 grams
Fiber: 5 grams
MCT Oil: 3 grams
Electrolyte Tablets: 1 serving
Goji Berry Powder: 05 grams
Green Tea Powder: 0.06 grams
Probiotic (1 billion colony): 0.07 grams
Multivitamin: 1 daily dosage (CVS Private Label Brand)
Coconut Milk: 40 grams

### Original Unflavored Trial 1:

### TIC: 0.03

### Masking: 0.08

Sensory: 4 grams
Pea: 4.5 grams
Coffee Flavor: 3 grams
Coconut Sugar: 2 grams
Fiber: 5 grams
MCT: 3 grams
Electrolyte Tablets: 1 serving
Goji Berry Powder: 05 grams
Green Tea Powder: 0.06 grams
Probiotic (1 billion colony): 0.07 grams
Multivitamin: 1 daily dosage (CVS Private Label Brand)
Coconut Milk: 35 grams
Very paint like

### Neutral Smell

### Great Consistency

An embodiment of the present invention may be as follows:

| | | Amount | |
|---|---|---|---|
| Marketable Categories | Ingredient Used | Used | |
| TOTAL VOLUME: | | | |
| Protein | N/A | | |
| | BCAA (K CUP) | 0.8 | as much as |
| | | | 1 egg white |
| Creaming Agent | | | |
| “Healthy” Fats | RICHMIX or CBF | 3.5 | |
| | * this is a powdered healthier | | |
| | creaming/fat agent | | |
| Prebiotic Dietary Fiber | | | |
| Multivitamin | 1 CVS ® Tablet Grinded (K CUP ®) | 1.54 | |
| Antioxidants | Goji ® Berry Powder (K CUP ®) | 0.05 | |
| | Green Tea Extract (K CUP ®) | 0.06 | |
| Probiotics | Gandenen(g) Probiotic Powder (500 mil) | 0.03 | |
| | (K CUP ®) | | |
| Electrolytes | Medique ® Tablet (K CUP ®) | 0.25 | |
| Natural Flavors | French Vanilla (K CUP ®) | 0.5 | |
| | Vanilla Flavor (K CUP ®) | 0.5 | |
| Natural Sweeteners | Coconut Sugar (K CUP ®) | 4 | |
| Emulisfiers | Mocha (if needed for Mocha) | *1 | |
| PH Regulators | | | |
| Thickening Agents | | | |
| COFFEE IN K CUP ® | Instant Espresso | 3 | |
| Formula Performance | Score: 1-5 | Oct. 9, | |
| Ratings | (1 = Poor & 5 = Excellent) | 2016 | |
| Category | Vanilla: | Mocha: | |
| Solubility | 4.5 | 4.5 | |
| Taste | 5 | 4 | |
| Color | 5 | 5 | |
| Visual Appeal/Appearance | 5 | 5 | |
| Viscosity/Mouth Fat Feel on Tongue | 5 | 5 | |
| Smell Before Oral Consumption | 5 | 4 | |
| Clean Label Confidence | 5 | 5 | |
| Aftertaste | 5 | 5 | |
| Hunger Satiety upon completion | 5 | 5 | |
| Vegan Formulation (Y/N) | N | N | |
| | TOTAL (40): 44.5 | 43.5 | |

NOTES
vanilla:

| | | | % Total |
|---|---|---|---|
| Marketable Categories | Ingredient Used | Amount Used | Formula |
| TOTAL VOLUME: | | | |
| Protein | Pisane ® P9: 90% | 0.7 | |
| | BCAA | 2.6 gams | |
| | | (1 scoop) | |
| Creaming Agent | Sensory Sunflower HP-CL IP 50 | 3 | |
| “Healthy” Fats | MCT Oil powder | 1 | |
| Prebiotic Dietary Fiber | Orafti ® GR | 2 | |
| Multivitamin | 1 powdered tablet | | |
| Antioxidants | Goji ® Berry Powder | 0.05 | |
| | Green Tea Extract | 0.06 | |
| Probiotics | Gandenen ® Probiotic Powder | 0.03 | |
| | (500 mil) | | |
| Electrolytes | Medique ® Tablet | 2 tabs: .5 pains | |
| Natural Flavors | French Vanilla | .5 grams | |
| | Vanilla Flavor | .5 grams | |
| Natural Sweeteners | Sucrose | 5 grams | |
| | Masking Agent 29.400 powder | 0.08 | |
| Emulisfiers | | | |
| PH Regulators | N/A: Present in Sensory | | |
| | Effects | | |
| Thickening Agents | | | |
| Formula Performance | Score: 1-5 | Sep. 29, | |
| Ratings | (1 = Poor & 5 = Excellent) | 2016 | |
| Category | Vanilla: | | |
| Solubility | 4.5 | | |
| Taste | 3 | | |
| Color | 2 | | |
| Visual Appeal/Appearance | 2 | | |
| Viscosity/Mouth Fat Feel on Tongue | 3 | | |
| Smell Before Oral Consumption | 3 | | |
| Clean Label Confidence | 5 | | |
| Aftertaste | 3 | | |
| Hunger Saiety upon completion | | | |
| Vegan Formulation (Y/N) | Y | | |
| | TOTAL (40): 35 | | |

NOTES
vanilla:
Needs either CVS ® multi grounded up OR 1/3 of the tablet from Vitamin Shoppe. Either way, 1/3 multi might be a good idea
barely room for espresso roast, need more room
PROTEIN at even .7 pea: CLUMPS

| Marketable Categories | Ingredient Used | Amount Used |
|---|---|---|
| TOTAL VOLUME: | | |
| Protein | BCAA | 2.94 grams (1 scoop) |
| Creaming Agent | Sensory Sunflower HP-CL IP 50 | 3 |
| “Healthy” Fats | MCT Oil powder | 0.5 |
| Prebiotic Dietary Fiber | Orafti ® GR | 2 |
| Multivitamin | 1/3 powdered tabelet | |
| Antioxidants | Goji ® Berry Powder | 0.05 |
| | Green Tea Extract | 0.06 |
| Probiotics | Gandenen ® Probiotic Powder (500 mil) | 0.03 |
| Electrolytes | Medique Tablet | 2 tabs: .5 grams |
| Natural Flavors | French Vanilla | .5 grams |
| | Vanilla Flavor | |
| Natural Sweeteners | Sucrose | 5 grams |
| | Masking Agent 29.400 powder | 0.08 |
| Emulisfiers | | |
| PH Regulators | N/A: Present in Sensory Effects | |
| Thickening Agents | | |
| Formula Performance Ratings | Score: 1-5 (1 = Poor & 5 = Excellent) | Sep. 29, 2016 |
| Category | Vanilla: | |
| Solubility | 4.5 | |
| Taste | 3 | |
| Color | 2 | |
| Visual Appeal/Appearance | 2 | |
| Viscosity/Mouth Fat Feel on Tongue | 3 | |
| Smell Before Oral Consumption | 3 | |
| Clean Label Confidence | 5 | |
| Aftertaste | 3 | |
| Hunger Satiety upon completion | | |
| Vegan Formulation (Y/N) | Y | |
| | TOTAL (40): 35 | |

NOTES
vanilla:
clumped less but still a culprit
needs CVS ® multi at 1/3
Steven Musacchio: MS, CSCS, USAW

| | Ingredient | Amount |
|---|---|---|
| Marketable Categories | Used | Used |
| TOTAL VOLUME: | | |
| Protein | PISANE ® | 4.5 |
| | PEA | |
| | BCAA (K | 1.53 |
| | CUP ®) | |
| Creaming Agent | MCT Oil (K | 1 |
| | CUP) | |
| | COCONUT | 1 |
| | OIL (K CUP) | |
| “Healthy” Fats | SUNFLOWER | 4 |
| | PEA | |
| | POWDER | |
| | (PACKET) | |
| Prehiotic Dietary Fiber | Orafti GR (K | 1 |
| | CUP) | |
| Multivitamin | 1 CVS Tablet | 1.54 |
| | Grinded (K | |
| | CUP) | |
| Antioxidants | Goji Berry | 0.05 |
| | Powder (K | |
| | CUP) | |
| | Green Tea | 0.06 |
| | Extract (K | |
| | CUP) | |
| Probiotics | Gandenen | 0.03 |
| | Probiotic | |
| | Powder | |
| | (500 mil) (K | |
| | CUP) | |
| Electrolytes | Medique | 2 tabs: |
| | Tablet (K | .59 grams |
| | CUP) | |
| Natural Flavors | French Vanilla | 1 |
| | (PACKET) | |
| | Vanilla Flavor | 1 |
| | (PACKET) | |
| Natural Sweeteners | Coconut Sugar | 6 |
| | (PACKET) | |
| | Masking Agent | 0.08 |
| | 29.400 powder | |
| | (PACKET) | |
| Emulisfiers | | |
| PH Regulators | N/A: Present in | |
| | Sensory | |
| | Effects | |
| Thickening Agents | | |
| COFFEE IN K CUP | Instant | 6 |
| | Espresso | |
| | Score: 1-5 | |
| | 1 = Poor & | Oct. 4, |
| Formula Performance Ratings | 5 = Excellent) | 2016 |
| Category | Vanilla : | |
| Solubility | 3.5 | |
| Taste | 3 | |
| Color | 4.5 | |
| Visual Appeal/Appearance | 4 | |
| Viscosity/Mouth Fat Feel on Tongue | 4 | |
| Smell Before Oral Consumption | 3 | |
| Clean Label Confidence | 5 | |
| Aftertaste | 3 | |
| Hunger Saiety upon completion | | |
| Vegan Formulation (Y/N) | Y | |
| | TOTAL (40): 29.5 | |

NOTES
vanilla:
Picking up on a strong smell without the vanilla extract
Needs Bean Instant protein to blend better and smell and taste better due to no extract.
Also needs a better vegan powder due to pea smell. use the BX 80 powder.
Needs more vanilla . . .
Needs less Espresso
Needs a powdered multi and electro if possible

| Marketable | | Amount | |
|---|---|---|---|
| Categories | Ingredient Used | Used | |
| TOTAL VOLUME: | | | |
| Protein | N/A | | |
| | BCAA (K CUP) | 0.8 | as much |
| | | | as 1 egg |
| | | | white |
| Creaming Agent | | | |
| “Healthy” Fats | RICHMIX | 3.5 | |
| Prebiotic Dietary Fiber | | | |
| Multivitamin | 1 CVS Tablet Grinded | 1.54 | |
| | (K CUP) | | |
| Antioxidants | Goji Berry Powder (K | 0.05 | |
| | CUP) | | |
| | Green Tea Extract (K | 0.06 | |
| | CUP) | | |
| Probiotics | Gandenen Probiotic | 0.03 | |
| | Powder (500 mil) (K | | |
| | CUP) | | |
| Electrolytes | Medique Tablet (K | 0.25 | |
| | CUP) | | |
| Natural Flavors | French Vanilla | 0.5 | |
| | (PACKET) | | |
| | Vanilla Flavor | 0.5 | |
| | (PACKET) | | |
| Natural Sweeteners | Coconut Sugar | 4 | |
| | (PACKET) | | |
| Emulisfiers | Mocha (if needed for | *1 | |
| | Mocha) | | |
| PH Regulators | | | |
| Thickening Agents | | | |
| COFFEE IN K CUP | Instant Espresso | 3 | |
| Formula | Score: 1-5 | | |
| Performance | (1 = Poor & | Oct. 9, | |
| Ratings | 5 = Excellent) | 2016 | |
| Category | Vanilla: | Mocha: | |
| Solubility | 4.5 | 4.5 | |
| Taste | 5 | 4 | |
| Color | 5 | 5 | |
| Visual | 5 | 5 | |
| Appeal/Appearance | | | |
| Viscosity/Mouth Fat Feel | 5 | 5 | |
| on Tongue: | | | |
| Smell Before Oral | 5 | 4 | |
| Consumption | | | |
| Clean Label Confidence | 5 | 5 | |
| Aftertaste | 5 | 5 | |
| Hunger Satiety upon | 5 | 5 | |
| completion | | | |
| Vegan Formulation (Y/N) | n | n | |
| | TOTAL (40): 44.5 | 41.5 | |

NOTES
vanilla:

| | | Amount |
|---|---|---|
| Marketable Categories | Ingredient Used | Used |
| TOTAL VOLUME: | | |
| Protein | BEAN BLEND (PACKET) | 6.5 |
| | BCAA (K CUP) | 1.53 |
| Creaming Agent | MCT Oil (K CUP) | 1 |
| | COCONUT OIL (K CUP) | 1 |
| “Healthy” Fats | JERZEE CWS 80 BXS (PACKET) | 5 |
| Prebiotic Dietary Fiber | Orafti GR (K CUP) | 1 |
| Multivitamin | 1 CVS Tablet Grinded (K CUP) | 1.54 |
| Antioxidants | Goji Berry Powder (K CUP) | 0.05 |
| | Green Tea Extract (K CUP) | 0.06 |
| Probiotics | Gandenen Probiotic Powder (500 mil)(K CUP) | 0.03 |
| Electrolytes | Medique Tablet (K CUP) | 2 tabs: .59 grams |
| Natural Flavors | French Vanilla (PACKET) | 1.5 |
| | Vanilla Flavor (PACKET) | 1.5 |
| Natural Sweeteners | Coconut Sugar (PACKET) | 6 |
| | Masking Agent 29.400 | 0.08 |
| | powder (PACKET) | |
| Emulsifiers | | |
| PH Regulators | N/A: Present in Sensory Effects | |
| Thickening Agents | | |
| COFFEE IN K CUP | Instant Espresso | 4 |
| Formula Performance Ratings | Score: 1-5 (1 = Poor & 5 = Excellent) | 10.4.16 |
| | Vanilla: | |
| Category | | |
| Solubility | 4.5 | |
| Taste | 4 | |
| Color | 4.5 | |
| Visual Appeal/Appearance | 4 | |
| Viscosity/Mouth Fat Feel on Tongue | 4 | |
| Smell Before Oral Consumption | 4 | |
| Clean Label Confidence | 5 | |
| Aftertaste | 4 | |
| Hunger Saiety upon completion | | |
| Vegan Formulation (Y/N) | Y | |
| NOTES | TOTAL (40): 33.5 | |
| vanilla: | | |
| Smelled Simply Vanilla | | |
| Nice and Sweet | | |
| No pea smell or taste . . . bean is better | | |
| dissolved much better | | |
| * The K Cup portion needs a little less | | |
| “stuff” to help with perfect dissolvability | | |

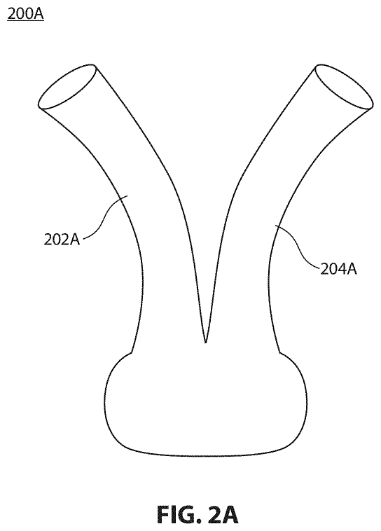

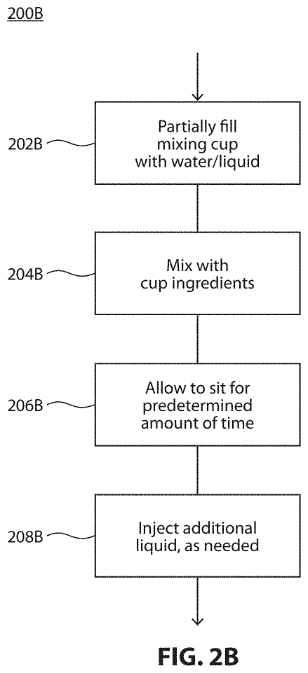

As illustrated in FIG. 2A, apparatus 200A is shown having two chambers (202A, 204A). For example, a first chamber 202A may be filled with a creaming recipe (protein, fiber, creaming, healthy fats, electrolytes, antioxidants, etc.), and the second chamber 204A may have a sealed flap, for example, and may contain just the little multi and exotic fluids. That way, it's just a 1-2 ml of fluid that's dropped into the coffee like a potion and would stir in easily as it's a minute amount. This would also give people the ability to use one half the creamer, and save the other half for later if they like their coffee with only a touch of cream.

Referring to FIG. 2B, flowchart 200B illustrates at least one illustrative embodiment of the present invention. In step 202B, a mixing cup may be partially filled with a liquid (e.g., water, milk) received from chamber 202A, for example. In step 204B, the mixing cup may be partially filled with certain ingredients (e.g., vitamins, protein powder, etc.) and received from chamber 204A, for example, and mixed. In step 206B, and if desired, the mixture may sit for a certain amount of time, as specified by a recipe, for example. In step 208B, and if desired, additional liquid may be injected into the mixing cup.

In an embodiment of the present invention, a “K-cup” design may be used. The composition of the present invention may include protein powder which may be included in quantities greater than 1 gram. The rate of water. the size of the “K-cup”, and the small exit hole and entrance hole all posed problems with getting a substantial amount of the powdered protein into solution. Protein powders generally require agitation and time to full hydrate. This obstacle was overcome by using the above referenced CORELATTE ingredients and adding about 5 grams of vegan protein powder which may be mixed with just enough water to make it aqueous inside the “K-cup”. The mixing process may be initiated by the user—for example, and may be performed prior to use with a coffee machine and or may be performed by the machine itself. For example, a coffee machine suitable for use with a “K-cup” may first partially fill the “K-cup” with water which may provide mixing of the “K-cup” ingredients through the turbulence of filing the “K-cup”. The injected liquid, usually. but not limited to water, may be allowed to remain in the “K-cup” for a predetermined period of time, such as, for example, 30 seconds. The “K-cup” may also be physically agitated by the machine for a similar period of time after liquid is added. As would be understood by those skilled in the mechanical coffee marker realm, the “K-cup” holder portion may be actuated into a side-to-side motion, for example, to enhance the mixing and “steeping” of the “K-cup” ingredients. Once the liquid as suitably interacted with the “K-cup” ingredients, additional liquid may be introduced to commence traditional brewing features.

As used herein, a “K-cup” may also mean a bag or any other apparatus which may be used with an automated beverage machine. In an embodiment of the present invention, various protein shakes formulations may be used which are shelf stable.

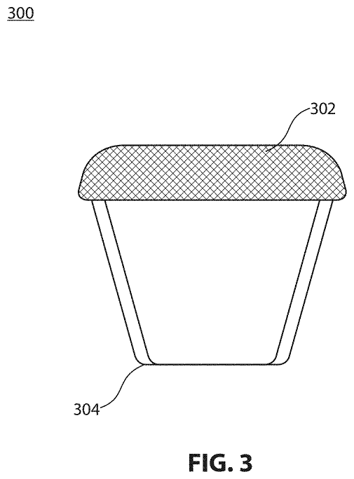

In an embodiment of the present invention, and as illustrated in FIG. 3, a “K-cup” with either the same plastic thickness, or a slightly thicker wall may be used. The top may have a film seal to allow puncture into the sealed contents of the “K-cup”. Alternatively, a reinforced, tamper-proof cap, much like a milk gallon or pepto-bismol top, may be provided. Such a device may protect the film to keep any accidental tearing causing spoilage. In an embodiment of the present invention, a whisk or ball, made of plastic, may be contained in the “K-cup” to aid in mixing of the “K-cup” contents, Such a “Blender ball” may be used to aid in the full emulsifying and/or putting into solution, certain aspects of the “K-cup” contents into a beverage. The blending aid may be a single apparatus or may be a plurality of devices made of any suitable material, such as, for example, plastic. Such a device may allow for greater agitation by the user and/or the machine and may activated by shacking the “K-cup” and/or by the energy providing with the introduction of a liquid. For example, such agitation may take place for some period of time prior to full dispensing and/or brewing of a cup of coffee, for example, and may last for 5 seconds, for example.

In an embodiment of the present invention, to provide for increased amounts of proteins and/or nutrients into solution. filters and/or impregnated mediums may be employed within a “K-cup”. For example, a “milli-pore” filter/medium may be used in a “K-cup” and may contain any number of ingredients, or the entire recipe if need be. They would allow the water to saturate the powders a little longer, thus giving the surface area of each particle more ability to hydrate/get in contact with water molecules. The ingredients may be “trapped” between two filter layers and/or provided in a smaller form, such as in a nano size, to allow for greater in solution percentages of the target ingredients.

Such a method may be quite beneficial for certain ingredients such as vitamins, fats/emulsions, and any new health-food ingredient that might arise in time that does not do well with the rate of water flow that a coffee machine generates. Similarly, this may be beneficial for manufacturing purposes, as not all companies could be set up to blend certain dry ingredients. These milli-pores could act as “suitcases” for CORELATTE, thus allowing a co-packer to easily blend, seal and ship. These could then be inserted into K-cup for easy labeling and distribution.

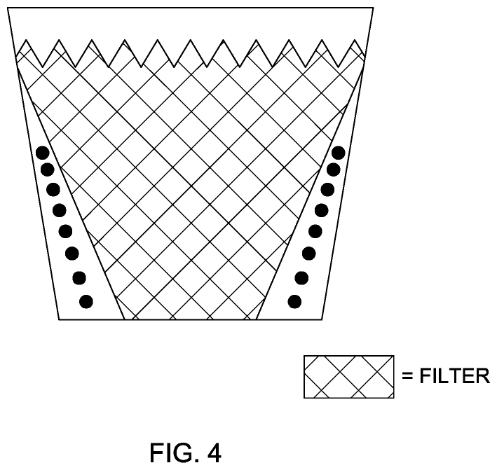

In view of FIG. 4, a reusable cup, such as a K-Cup, nutrient powder may be inserted by a first auger and placed behind a filter. In one example, the nutrient powder may be inserted prior to the filter being placed into the cup. After insertion of the filter within the cup, ingredients (e.g., coffee grounds, tea leaves) may inserted into the filter by a second auger.

The present invention may use ingredients such as amino acids, antioxidants, fats, multivitamins, instant espresso/coffee, flavoring, etc., mixed together and in a “K-cup”. For example, using the present invention may allow for more than 90% hydrating and dispensing of certain ingredients in the “K-cup” into a “cup of coffee.” To aid in the full dispensing of “K-cup” ingredients, the dispensing of water from the coffee machine may be provided at a variable rate, such that at least some portion of the water dispensed when making a beverage is provided at a slower rate to allow for the substantial hydration of certain ingredients.

I claim:

1. A container for mixing at least two consumables, the container comprising:
at least two more separate chambers for receiving the at least two consumables;
at least one additional chamber for:
receiving the at least two consumables from the at least two or more separate chambers;
mixing the at least two consumables into a drinkable substance; and
delivering the drinkable substance to an external container.

2. The container of claim 1, wherein amounts the at least two consumables are predefined.

3. The container of claim 1, wherein the at least two consumables include protein, fiber, creaming, healthy fats, electrolytes, or antioxidants.

4. The container of claim 1, wherein the at least two consumables include dietary supplements.

5. The container of claim 1, wherein the mixing is performed in response to a user command.

6. The container of claim 1, wherein the mixing is performed as part of an automated process.
